(19) United States
(12) Patent Application Publication
(10) Pub. No.: US 2015/0243123 A1
(43) Pub. Date: Aug. 27, 2015

(54) GAMING MACHINE WITH VIDEO GAME SEARCH CAPABILITY

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 14/610,830

(22) Filed: Jan. 30, 2015

Related U.S. Application Data
(60) Provisional application No. 61/934,937, filed on Feb. 3, 2014.

(51) Int. Cl. G07F 17/32

(52) U.S. Cl. CPC G07F 17/3211

(57) ABSTRACT

A method, system and architecture providing a casino-style video gaming machine, e.g. video slot gaming machine, with game selection capability. The gaming machine has at least one video display for displaying a player interface including at least one video game presentation area displaying one or more player-selectable video game visual indicia, and at least one search indicia selectable by the player to search information about a plurality of video games available for play using the video gaming machine, the information comprising video game characteristics. In response to input indicative of a player's selection of a search indicia, a search of a video game database is performed to identify one or more video games satisfying the search criteria and the at least one video game presentation area is updated to display indicia corresponding to those video games identified in the search of the video game database.

### RELATED APPLICATION DATA

This application claims priority to U.S. Provisional Patent Application Ser. No. 61/934,937, filed Feb. 3, 2014.

### FIELD OF THE INVENTION

The present invention relates casino-style video games such as wagering games presented at casino-style video gaming machines.

### BACKGROUND OF THE INVENTION

A casino-style video gaming machine may provide a large number of casino-style video games for play making it difficult for a player to choose a video game to play using the casino video gaming machine. Additionally, a player may be unfamiliar with each of the video games, e.g., characteristics of the video game. A player may be presented with one or more video display screens displaying a number of images representing video games available to play using the video gaming machine; however and unless the player has actually played a video game or is otherwise familiar with the games, the player is likely to have difficulty identifying a video game presented by the video gaming machine that the player may like to play. This may result in frustration on the part of the player and may cause the player to simply avoid playing any of the video games offered by the gaming machine.

A mechanism to facilitate a player's casino-style video game selection using a casino-style video gaming machine is desired.

### SUMMARY OF THE INVENTION

Embodiments of the invention comprise methods and systems providing a casino-style video game selection capability for selecting one or more video games, e.g., video slot game(s), presented by a casino-style video gaming machine.

In accordance with at least one embodiment, a system and method provides a casino-style video gaming machine, e.g. video slot gaming machine, with game selection capability. In accordance with such an embodiment, the video gaming machine has at least one video display for displaying a player interface, e.g. a video game search interface, the player interface comprising at least one video game presentation area displaying one or more video game indicia, e.g. player-selectable visual indicia, and at least one selection indicia selectable by the player to search information about a plurality of video games available for play using the video gaming machine, the information comprising video game characteristics. A video game database maintains searchable information about each of the plurality of video games, including video game characteristics. Each selection indicator representing search criteria for use in querying the video game database to identify one or more of the video games meeting the search criteria. In response to input indicative of a player's selection of a search indicia, a search of the video game database is performed to identify the one or more video games satisfying the search criteria and the at least one video game presentation area is updated to display the one or more video game indicia corresponding to the one or more video games identified in the search of the video game database.

Further objects, features, and advantages of the present invention over the prior art will become apparent from the detailed description of the drawings which follows, when considered with the attached figures.

### DESCRIPTION OF THE DRAWINGS

FIG. 1 illustrates a casino gaming machine displaying selection functionality.

FIG. 2 illustrates examples of casino-style video game characteristics for use in video game selection.

FIG. 3 illustrates an example of a style selection criteria menu.

FIG. 4 illustrates an example of a features selection criteria menu.

FIG. 5 diagrammatically illustrates components that may be used in video game selection.

FIG. 6 diagrammatically illustrates a video game selection process flow.

FIG. 7 diagrammatically illustrates a video game style selection process flow.

FIG. 8 diagrammatically illustrates a video game features selection process flow.

FIG. 9 illustrates an example of a casino gaming machine display in response to a “top ten” selection.

FIG. 10 illustrates an example of the casino gaming machine display in response to a line selection.

FIG. 11 illustrates an example of a casino gaming machine displaying video game representations in response to an all games selection.

FIG. 12 diagrammatically illustrates a video game lines selection process flow.

FIG. 13 diagrammatically illustrates system components including one or more casino gaming machines.

FIG. 14 diagrammatically illustrates components of a casino gaming machine.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of playing and presenting games. In a preferred embodiment, the methods of game play and presentation are implemented via a casino gaming machine or device 100. Such a casino gaming machine 100 may have various configurations.

The gaming machine 100 may be located at a casino (and as such may be referred to as a “casino gaming machine”). As described below, the gaming machine 100 may be part of a gaming system, such as a casino gaming system which links two or more of the gaming machines or one or more gaming machines with other devices, such as one or more table games, kiosks, accounting systems or servers, progressive systems or servers, player tracking systems or servers or the like.

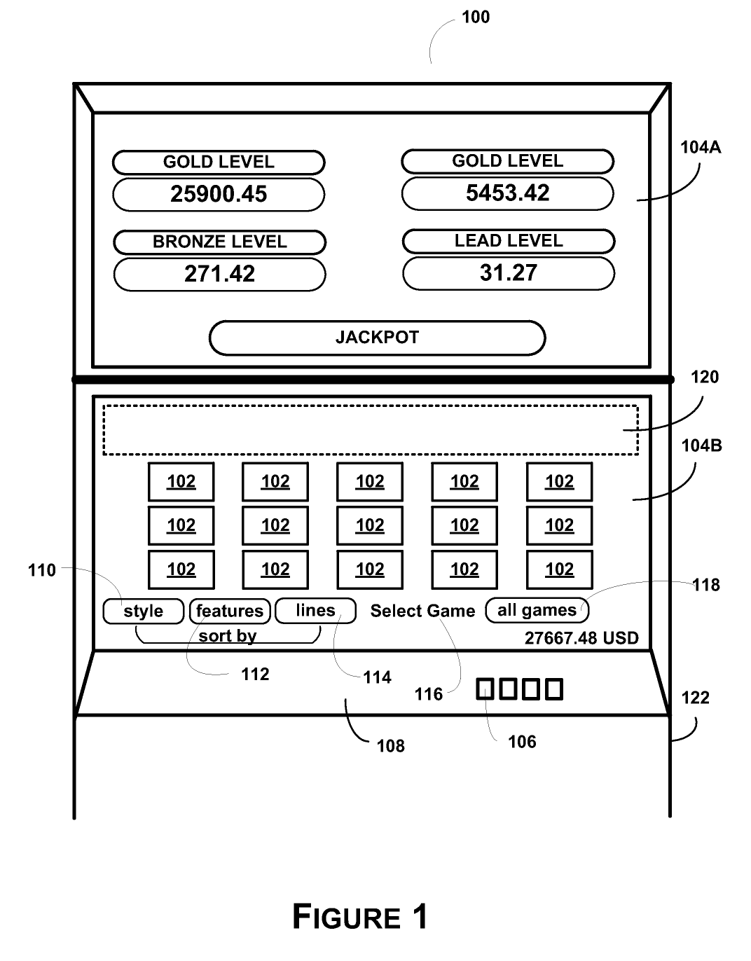

One configuration of a gaming machine 100 is illustrated in FIG. 1. As illustrated, the gaming machine 100 generally comprises a housing or cabinet 122 for supporting and/or enclosing various components required for operation of the gaming machine. The configuration of the gaming machine 100 may vary. In the embodiment illustrated, the gaming machine 100 has an “upright” configuration. However, the gaming machine 100 could have other configurations, shapes or dimensions (such as being of a “slant”-type, “bar-top” or other configuration as is well known to those of skill in the art).

The gaming machine 100 preferably includes at least one display device 104 configured to display game information. The display device 104 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). In accordance with a preferred embodiment, at least one display device 104 comprises a touchscreen. The display 104 may be capable of projecting or displaying a wide variety of information, including images, symbols and other indicia or information associated with game play, game promotion or other events. The gaming machine 100 might include more than one display device 104. In the example shown in FIG. 1, the gaming machine 100 comprises at least two display devices, e.g. display devices 104A and 104B, which are associated with the housing 122. Preferably, at least one of the display devices 104A and 104B is touch-sensitive. The gaming machine 100 might also include a top box or other portion. Such a top box might include one or more display devices 104, such as in addition to one or more main displays which are associated with the housing 122. Also, the gaming machine 100 might include side displays (such as mounted to the exterior of the housing 122) and might include multiple displays of differing sizes.

As described in more detail below, the gaming machine 100 is preferably configured to present one or more games upon a player making a monetary payment or wager. In this regard, as described in more detail below, the gaming machine 100 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 100 includes means for returning unused monetary funds and/or dispensing winnings to a player.

The gaming machine 100 preferably includes one or more player input devices (such as input buttons 106, plunger mechanisms, a touch-screen display, joystick, touch-pad or the like). These one or more input devices may be utilized by the player to facilitate game play, such as by providing input or instruction to the gaming machine 100. For example, such input devices may be utilized by a player to place a wager, cause the gaming machine 100 to initiate a game, to indicate cards to be held or discarded, to “cash out” of the gaming machine, or to provide various other inputs.

In one preferred embodiment, the gaming machine 100 includes at least one microprocessor or controller for controlling the gaming machine, including receiving player input and sending output signals for controlling the various components of the machine 100 (such as generating game information for display by the display 104). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 104 (such as information representing images of displayed cards, slot symbols or the like), for determining winning or losing game outcomes and for displaying information regarding awards for winning game outcomes, among other things.

The controller may be configured to execute machine readable code or “software” or otherwise process information, such as obtained from a remote server. Software or other instructions may be stored on a memory or data storage device. The memory may also store other information, such as pay table information. The gaming machine 100 may also include one or more random number generators for generating random numbers, such as for use in selecting cards and for presenting the game in a random fashion.

Preferably, the controller is configured to execute machine readable code or instructions which are configured to implement game play. For example, the controller of the gaming machine 100 may be configured to detect a wager, such as a signal from a player's depressing of the “bet one” button. Upon such an event and/or the player otherwise signaling the gaming machine to present the game, the controller may be configured to cause the game to be displayed on the at least one display 104. The controller may accept input from a player of the game via the one or more player input devices of the gaming machine 100.

In accordance with one or more embodiments, the controller is further configured to execute machine readable code or instructions which are configured to implement game selection techniques using game characteristics. In accordance with at least one such embodiment, the controller is configured to display a top-level selection menu comprising at least one selectable indicia of game characteristic search criteria using at least one display 104. In the example shown in FIG. 1, a top-level menu comprises style indicia 110, features indicia 112, lines indicia 114 and in all games indicia 118, each of which may be actuated by a player's touch, for example. In the example shown in FIG. 1, the top-level menu is displayed on one display 104; however it should be apparent that the menu may be displayed using any number of displays 104.

In accordance with one or more embodiments, each of the indicia 110, 112, 114 represents a type, or grouping, of, characteristics that the video games available for play using gaming machine 100 possess, and indicia 118 represents all of the characteristics possessed by the video games, such that selection of indicia 118 results in all of the games available via gaming machine 100 being selected for display via the gaming machine's display 104, as is discussed in more detail below. Actuation of one of the indicia 110, 112 and 114 may result in a sorting of video games by characteristic. In the example shown in FIG. 1, each indicia 102 represents a video games available for play using gaming machine 100. Preferably, each indicia 102 is selectable by the player via touch to invoke a corresponding game. Prompt 116 provides instruction to the player for selecting a video game.

In accordance with one or more embodiments, the controller is further configured to execute machine readable code or instructions which are configured to display at least one other selection menu, which may be displayed in area 120 of display 104B.

The gaming machine 100 may be configured to generate and present games in a stand-alone manner or it may be in communication with one or more external devices at one or more times. For example, the gaming machine 100 may be configured as a server based device and obtain game code or game outcome information from a remote game server (in which event the gaming machine controller may receive game information from the server, such as game outcome information, and use that server-generated information to present the game at the gaming machine). In accordance with one or more embodiments, the gaming machine 100 may be configured to transmit video game selection criteria specified by a player to a server and/or to receive video game search results from a server.

As indicated, the gaming machine 100 is configured to present one or more wagering games. Thus, the gaming machine 100 is preferably configured to accept value, such as in the form of coins, tokens, paper currency or other elements or devices representing value such as monetary funds. By way of a non-limiting example, the gaming machine 100 might include a coin acceptor for accepting coins. Of course, associated coin reading/verifying devices and coin storage devices may be associated with the gaming machine 100 if it is configured to accept coins. Likewise, the gaming machine 100 might include a media reader. Such a reader may be configured to accept and read/verify paper currency and/or other media such as tickets. Of course, in such event the gaming machine 100 may further be configured with one or more paper currency or ticket storage devices, such as cash boxes, and other paper currency or media handling devices (including transport devices).

The gaming machine 100 might also be configured to read FOBs, magnetic stripe cards or other media having data associated therewith and via which value or funds may be associated with the gaming machine 100.

In one embodiment, the gaming machine 100 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. For example, upon an award or at cash-out, associated funds may be paid to the player by the gaming machine 100 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference.

The gaming machine 100 may also include a player tracking device, such as a card reader and associated keypad. Such player tracking devices are well known and may permit the game operator to track play of players of the gaming machine. The tracked play may be utilized to offer player bonuses or awards.

It will be appreciated that the gaming machine illustrated in FIG. 1 is only exemplary of one embodiment of a gaming machine. For example, it is possible to for the gaming machine to have various other configurations, including different shapes and styles and having different components than as just described.

For example, it is possible for the game of the invention to be presented on a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays. The games of the invention could also be presented by or at hand-held devices, such as PDAs, cellular phones, tablet computing devices or the like.

A casino may have numerous such gaming machines 100, such as located on a casino floor or in other locations. Of course, such gaming machines 100 might be used in other environments, such as an airport, a bar or tavern or other locations.

In the example shown in FIG. 1, the player may initiate a video game by selecting a video game using its corresponding indicia 102. Each indicia 102 may comprise an image, e.g. a graphical representation, icon, etc., title, description and the like identifying the corresponding video game. The example of FIG. 1 further illustrates that one of the displays 104 may be used for video game selection, e.g. display 104B, while another may be used to display additional, or other information, such as jackpot information displayed using display 104A in FIG. 1. In some cases, more than one display 104 may be used to display indicia 102 of video games available using gaming machine 100. By way of a non-limiting example, display 104B may be used in a case that additional space is needed to display indicia 102 of video games meeting the selection criteria.

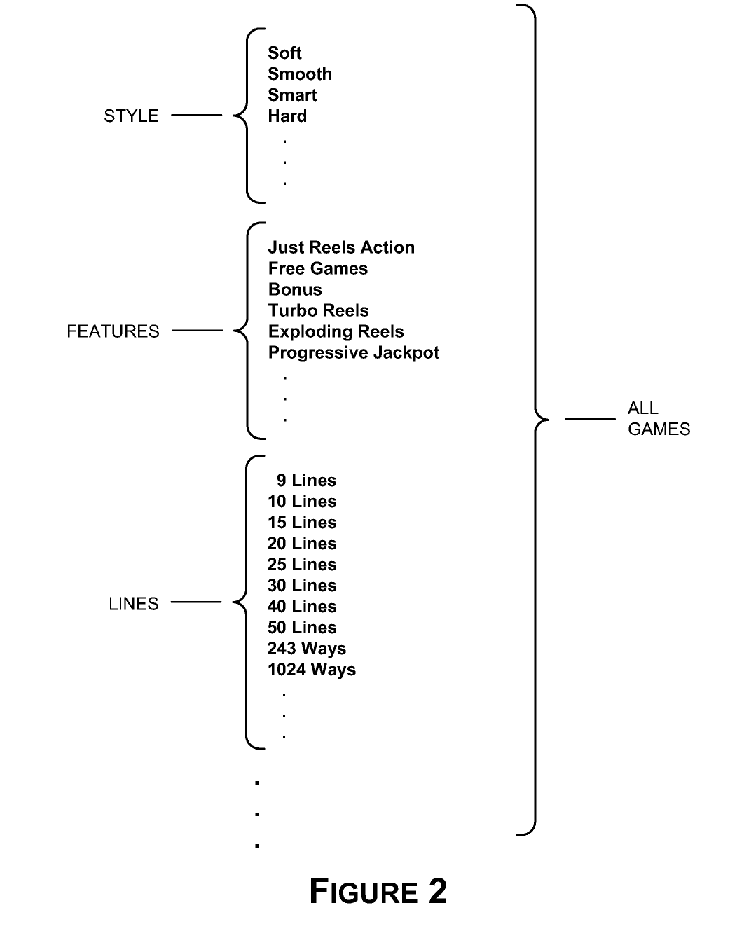

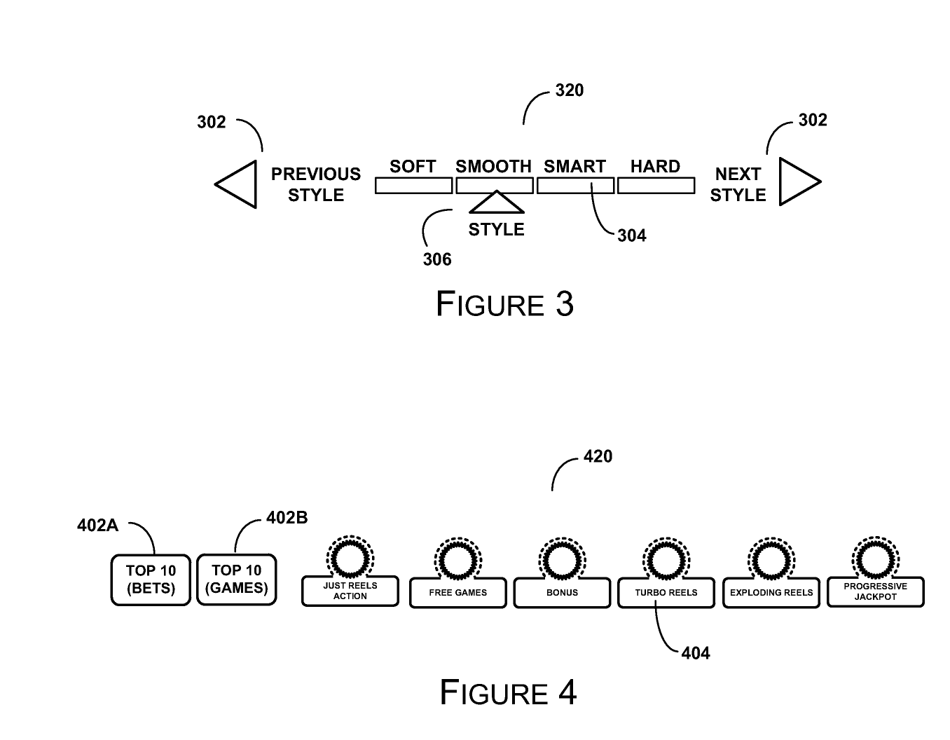

FIG. 2 provides examples of video game characteristics that may be used in video games search and selection. In the example, a style characteristics may be broken down into various style characteristics, such as and without limitation soft, smooth, smart, hard etc. A player's selection of indicia 112 of FIG. 1, for example, may result in the games available using the gaming machine 100 to be sorted by each game's feature characteristic. The sorting may be done for purposes of displaying the games using the gaming machine's 100 display 104, such that games with a soft style are grouped together, games with a smooth style are grouped together, etc. for display. Furthermore, in response to selection of indicia 110 of FIG. 1, the gaming machine's 100 display 104 displays a style menu such as that shown in FIG. 3. The style menu 320 may be displayed in area 120 of display 104A shown in FIG. 1, for example.

In the example shown in FIG. 3, menu 320 comprises a number of indicia 304, each of which corresponds to a style characteristic, e.g. soft, smooth, smart, hard etc. Of course, it should be apparent that other and/or additional video game style characteristics may be used with embodiments of the present invention.

In the example shown in FIG. 3, menu 320 includes a scrolling capability using arrows 302, selection of one scrolling indicia 302 allows the player to see one or more previous style characteristics and selection of another scrolling indicia 302 allows the player to see one or more next style characteristics. Selection by the player of a style characteristic using indicia 304 may result in feedback indicating the player's selection. In the example of FIG. 3, feedback indicia 306, which comprises an arrow and a “Style” indicator, may be used in response to a player's selection of a style characteristic from menu 320, e.g. as confirmation of the player's selection. Also, in response to the player's selection of an indicia 304, the gaming machine 100 displays, via at least one video display 104, those video games having the selected style characteristic, and in further response to a style selection those video games lacking the selected style characteristic may be excluded from being displayed via the at least one video display 104 of the gaming machine 100. By way of a non-limiting example, selection of indicia 304 corresponding to a smooth characteristic results in those video games having the smooth characteristic being displayed via at least one video display 104 of the gaming machine 100; and in response to a smooth style characteristic selection those video games lacking the smooth style characteristic may be excluded from being displayed.

Referring again to FIG. 2, a features may comprise various features characteristics, such as just reels action, free games, bonus, turbo wheels, exploding wheels, progressive jackpot etc. features characteristics. A player's selection of indicia 110 of FIG. 1 may result in the gaming machine's 100 available games being sorted, or grouped, by feature characteristic, such that the games may be displayed sorted by feature characteristic, e.g. all games having features characteristics may be sorted so that all games having a free game(s) characteristic may be grouped together. Furthermore, in response to selection of indicia 112 of FIG. 1, the gaming machine's 100 display 104 displays a features menu such as that shown in FIG. 4.

In the example shown in FIG. 4, menu 420 comprises a number of indicia 404, each of which corresponds to a feature characteristic, e.g. just reels action, free games, bonus, turbo reels, exploding reels, progressive jackpot, etc. Although not shown in the example shown in FIG. 4, a scrolling capability may be provided, such that a player may scroll to view features not currently displayed in the menu 420.

Selection by the player of a feature characteristic using indicia 404 may result in feedback by the gaming machine 100 indicating the selection. An indicia such as indicia 306 of FIG. 3 may be used. It should be apparent that any type of feedback may be used, including one or more changes in the visual representation of indicia 404, e.g. blinking, highlight, change in size, color, etc. Also, in response to the player's selection of an indicia 404, the gaming machine 100 displays, via at least one video display 104, those video games having the selected feature characteristic, and those video games lacking the selected feature characteristic may be excluded from being displayed via the at least one video display 104 of the gaming machine 100. By way of a non-limiting example, selection of indicia 404 corresponding to a turbo reels feature characteristic results in those video games having the turbo reels feature characteristic being displayed via at least one video display 104 of the gaming machine 100; and those video games lacking the turbo reels feature characteristic may thereby be excluded from being displayed.

In accordance with one or more embodiments, a player may elect to view a certain number of video games by selecting a “Top n” selection indicia, such as indicia 402 shown in connection with menu 420. While the indicia 402 is shown in connection with feature characteristics menu 420, it should be apparent that one or more “Top n” selection indicia might be used in connection with any interface provided in accordance with embodiments of the present invention, including and without limitation the style characteristics menu 320 of FIG. 3. Additionally, it should be apparent that any number may be used for “n.”

Referring again to FIG. 4, two “Top n” indicia 402 are shown, e.g., “Top 10 (Bets)” and “Top 10 (Games)”. While “Bets” and “Games” are illustrated in FIG. 4, it should be apparent that any criteria for ordering, or ranking, may be used. By way of a non-limiting example, games may be ordered by the amount, or size, of bets that have been or may be wagered, so that the top ten highest-wagering games may be displayed in response to the player's selection of indicia 402A.

By way of another non-limiting, games may be ordered by player popularity, such that the top ten popular games may be displayed in response to the player's selection of indicia 402B. Popularity may be determined using explicit and/or implicit information, which information may also be referred to herein as feedback and/or player preference. By way of some non-limiting example, explicit feedback may be provided in the form of ranking feedback, such as like/dislike, yes/no, or a number in a range of numbers such as and without limitation a number from 1 to 10. By way of some further non-limiting examples, implicit feedback may be in the form of observed player behavior, such as and without limitation the number of times a game is played by a player or players, the length of time a game is played, etc. Popularity may be determined from feedback provided by a given player and/or determined from feedback provided by a community, or collection, of players.

In accordance with one or more embodiments, a “Top n” ordering may be combined with one or more video game characteristics. By way of a non-limiting example, a “Top n” ordering may result in a display of the top “n” most popular games having a given one or more feature characteristic(s), style characteristic(s), lines characteristic(s), etc. By way of a further non-limiting example, a “Top n” ordering may result in a display of the top “n” highest wager “turbo reels” games. In this example, the player may select the indicia 404 corresponding to the turbo reels feature characteristic from the features menu 420 and then select indicia 402A, or vice versa.

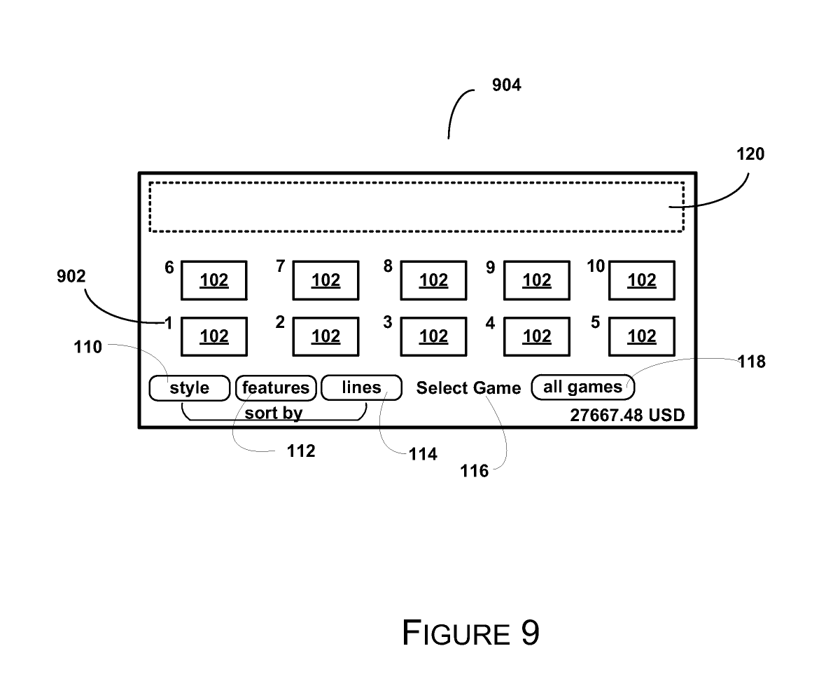

FIG. 9 illustrates an example of a casino gaming machine display in response to a “top ten” selection. In the example of FIG. 9, display 904, which might be one of displays 104A or 104B, of gaming machine 100 displays ten occurrences of video game indicia 102 corresponding to the top “n” games, e.g. the top “n” wagering or popular games. Additionally and in the example, each indicia 102 has an associated number 902 indicating the position of the corresponding video game in the top “n” games. Of course, it should be apparent that any approach may be used to indicate an ordering other than associating a number with each indicia 102. By way of one non-limiting example, an indication that the games are ordered highest to lowest from left to right and bottom to top might be used in the example in place of the numbers used in FIG. 9.

Referring again to FIG. 2, another example of a video game characteristic that may be used in selecting and/or sorting video games includes lines or ways to play a video game, such as and without limitation 9, 10, 20, 25, 30, 40, 50 lines, 243 ways, 1024 ways, etc. In accordance with one or more embodiments, line(s)/way(s) characteristics may be combined with one or more other video game characteristics. By way of a non-limiting example, line(s)/way(s) video game characteristics may be combined with style or features video game characteristics. By way of a non-limiting example, the player may select the indicia 404 corresponding to the turbo reels feature characteristic from the features menu 420 and then select lines indicia 114, or vice versa.

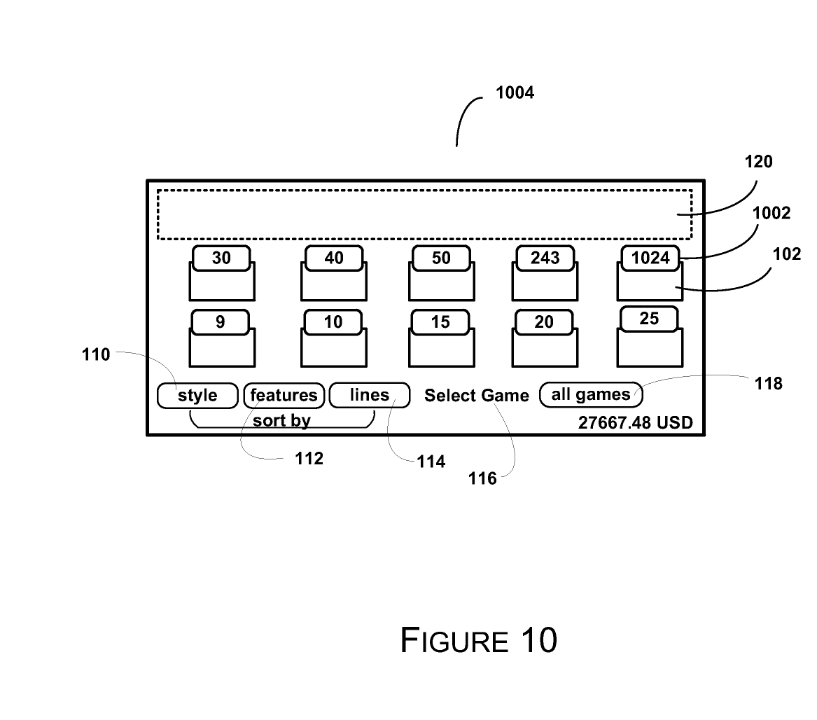

FIG. 10 provides an example of a casino gaming machine display in response to a lines characteristic selection. In the example of FIG. 10, display 1004, which might be one of displays 104A or 104B of the gaming machine 100, displays video game indicia 102 corresponding to one or more line(s)/way(s) associated with the lines characteristic. Additionally and in the example, each indicia 102 has an associated number 1002 indicating the number of lines/ways of the corresponding video game. Of course, it should be apparent that any approach may be used to indicate a line/way associated with a video game.

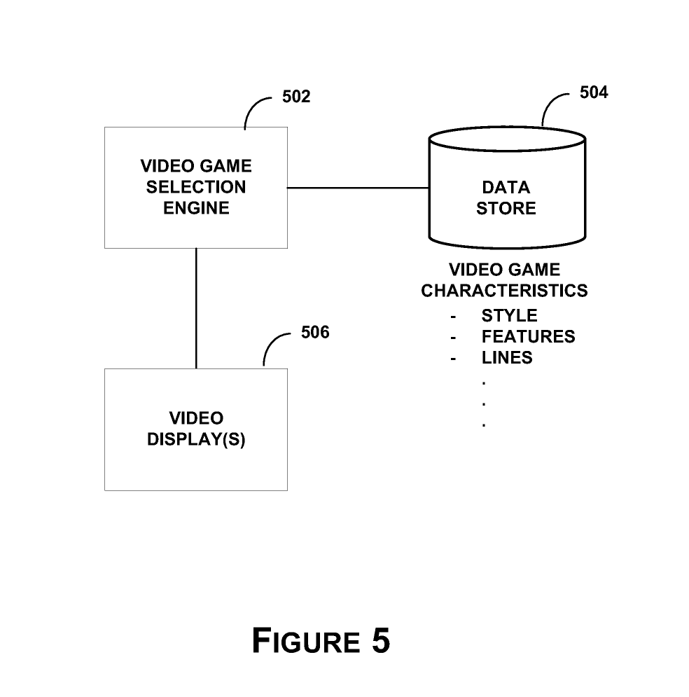

FIG. 5 diagrammatically illustrates components that may be used in video game selection. Engine 502 may comprise hardware and/or software configured in accordance with one or more embodiments of the present invention. By way of some non-limiting examples, engine 502 may comprise one or more processing units, e.g. central processing units (CPUs), etc., which may be internal and/or external to the gaming machine 100, which processing unit(s) is/are configured to execute code, program code, executable code, etc., to perform functionality in accordance with one or more embodiments of the invention. Such functionality includes, without limitation, searching data store 504 to identify one or more video games satisfying a player's search criteria, e.g. video game characteristics, popularity, wagering, etc., displaying, via video display(s) 506, the one or more video games identified in a search of data store 504, displaying, via video display(s) 506, one or more selection menus, etc. Engine 502 may be configured to implement one or more of the process flows described herein.

Data store 504 may be internal or external to the gaming machine 100, and may comprise one or more databases and/or data stores. Data store 504 may include one or more databases or other data storage and retrieval structure storing video game characteristics for any number of video games available for play using gaming machine 100, player preferences, such as explicit and/or implicit video game feedback, etc.

Video displays 506 may comprise one or more video displays 104 of the gaming machine 100. Video displays 506 may comprise any display available for displaying output generated by engine 502.

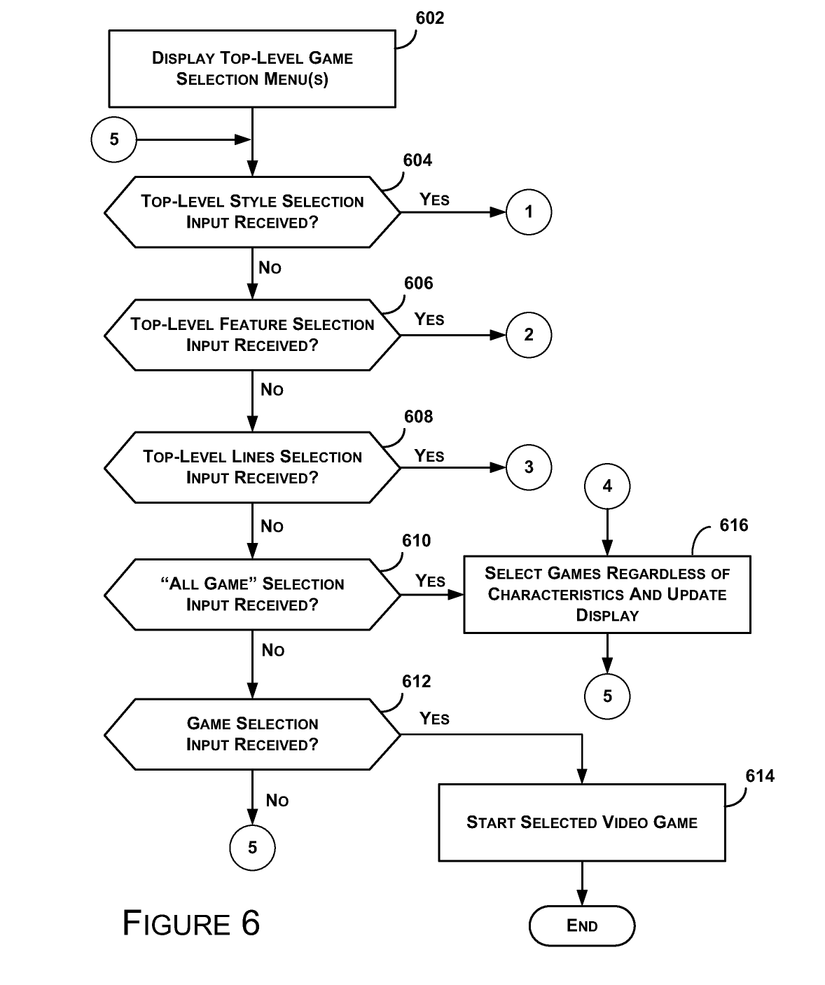

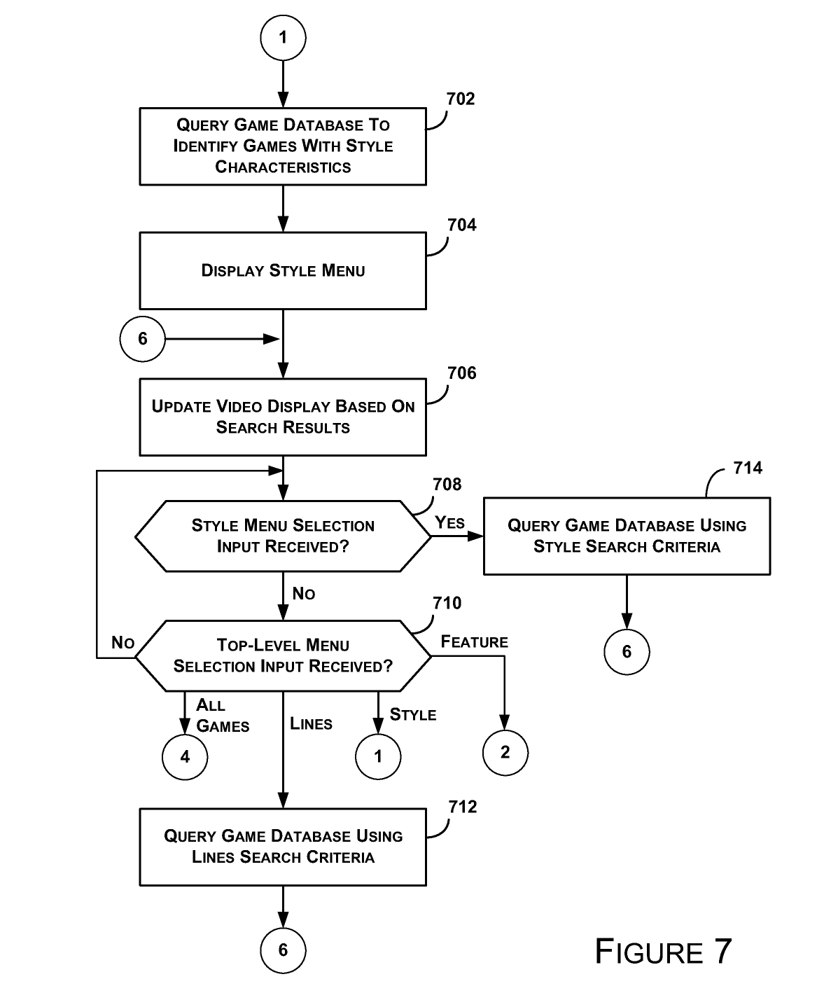

FIG. 6 diagrammatically illustrates a video game selection process flow. At step 602, a top-level game selection menu is displayed. By way of a non-limiting example, the top-level game selection menu may comprise indicia 110, 112 114 and 118 and prompt 116, and may be displayed at the gaming machine 100 on one or more of the video displays 104. Processing continues, at step 604, to determine whether the player has selected an indicia from the top-level menu. At step 604, a determination is made whether or not a style selection input is received, e.g. via selection of style indicia 110 by the player. If so, processing continues at step 702 of FIG. 7, where a query is performed to identify those video games with style characteristics. By way of a non-limiting example, data store 504 of FIG. 5 may be queried to identify those video games having style characteristics. At step 704, a style menu, e.g., style menu 320 of FIG. 3, is displayed, e.g. in menu area 120 of video display 104B of FIG. 1.

At step 706 of FIG. 7, the video display is updated based on the search results. By way of a non-limiting example, one or more of the video displays 104 of the gaming machine 100 may be updated to display indicia 102 of those video games identified in the search conducted at step 702.

At step 708, a determination is made whether or not a style menu selection is made by the player. By way of some non-limiting examples, the player may select one of the indicia 304 of style menu 320, e.g. a soft, smooth, smart or hard style characteristic. If so, processing continues at step 714 to query the game database, e.g. stored by the data store 504, using the style search criteria selected by the player, and processing continues at step 706 to update the video display based on the results of the search, e.g. to display those video games having the selected style and to exclude those games that lack the selected style.

If it is determined, at step 708, that no style menu selection input has been received, processing continues at step 710 to determine whether or not any top-level menu selection has been received. That is, the user may elect to view a selection of those video games having one or more style characteristics, which may be sorted by style, by selecting indicia 110, view a selection of those video games having one or more feature characteristics, which may sorted by feature, by selecting indicia 112, view all video games regardless of their characteristics, which may be sorted by style, feature, line characteristics, by selecting indicia 118, etc.

If it is determined, at step 710, that the player selected indicia 114, processing continues at step 712 to query the game database using the lines characteristic search criteria, and optionally any current feature and/or style characteristic(s) selected by the player, to identify those video games having line(s)/way(s) characteristics(s). Processing continues, at step 706, to update the video display.

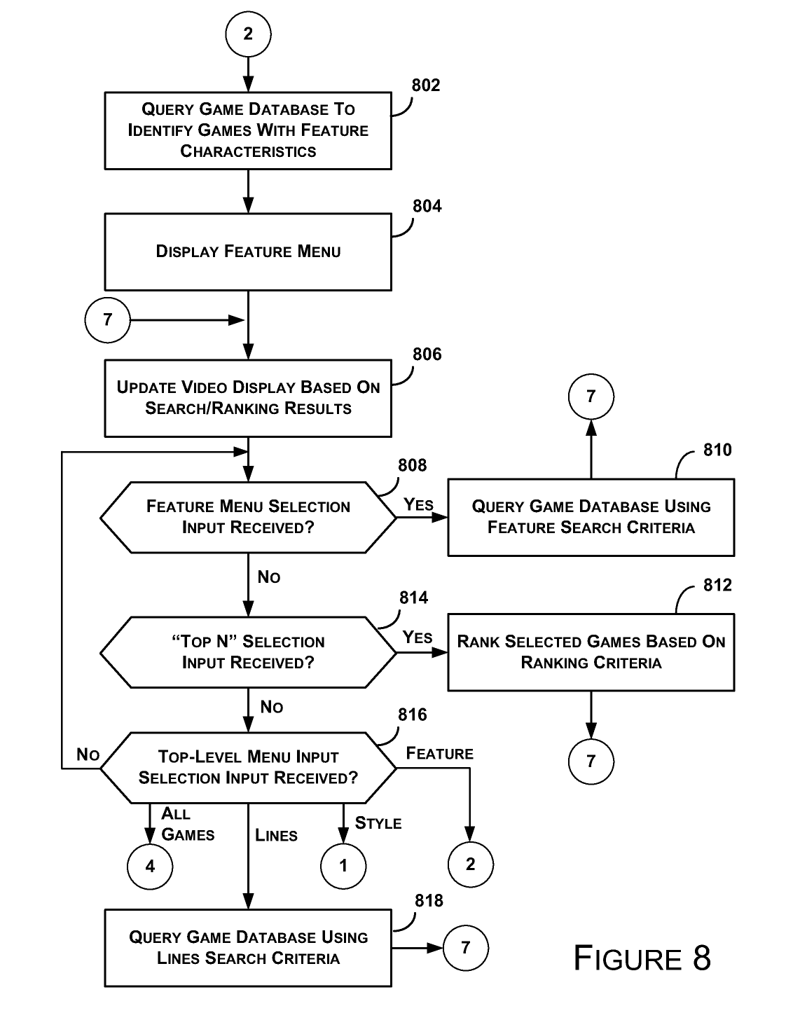

Returning to FIG. 6, if it is determined, at step 604, that top-level style selection input was not received, processing continues at step 606 to determine whether or not any top-level feature selection input was received, e.g. via selection of features indicia 112 by the player. If so, processing continues at step 802 of FIG. 8, where a query is performed to identify those video games with features characteristics. By way of a non-limiting example, data store 504 of FIG. 5 may be queried to identify those video games having feature characteristics. At step 804, a features menu, e.g., features menu 420 of FIG. 4, is displayed, e.g. in menu area 120 of video display 104B of FIG. 1.

At step 806 of FIG. 8, the video display is updated based on the search results. By way of a non-limiting example, one or more video displays 104 of the gaming machine 100 is updated to display indicia 102 of those video games identified in the search conducted at step 802, e.g. video games identified as having feature characteristics. At step 808, a determination is made whether or not a features menu selection is made by the player. By way of some non-limiting examples, the player may select one of the indicia 404 of feature menu 420, e.g. a just reels action, free games, bonus, turbo reels, exploding reels, progressive jackpot, etc. features characteristics. If so, processing continues at step 810 to query the database, e.g. data store 504, using the features search criteria selected by the player to identify those games satisfying the selected feature search criteria, and processing continues at step 806 to update the video display based on the results of the search, e.g. to display those video games having the selected feature and to exclude those games that lack the selected feature.

If it is determined, at step 808, that no feature menu selection was received, processing continues at step 814 to determine whether or not “Top n” menu selection input has been received. If so, processing continues at step 812 to rank video games, e.g. those video games currently being display, all video games, video games that are capable of being ranked, such as those that have a “bets” metric, a “games” metric or the like. A number n of the top ranked video games are selected at step 812 and processing continues at step 806 to update the video display, e.g. one or more of the video displays 104, to display the “n” top ranked video games ordered, or sorted, according to their respective rankings.

If it is determined, at step 814, that no “Top n” menu selection input has been received, processing continues at step 816 to determine whether or not any top-level menu selection was received. That is, the user may elect to view a selection of those video games having one or more style characteristics, which may be sorted by style, by selecting indicia 110, view a selection of those video games having one or more feature characteristics, which may be sorted by feature, by selecting indicia 112, view all video games regardless of their characteristics, which may be sorted by characteristic, by selecting indicia 118.

If it is determined, at step 816, that the player selected indicia 114, processing continues at step 818 to query the game database using the lines characteristic search criteria, and optionally any current feature and/or style characteristic(s) selected by the player, to identify those video games having line(s)/way(s) characteristics(s). Processing continues, at step 806, to update the video display.

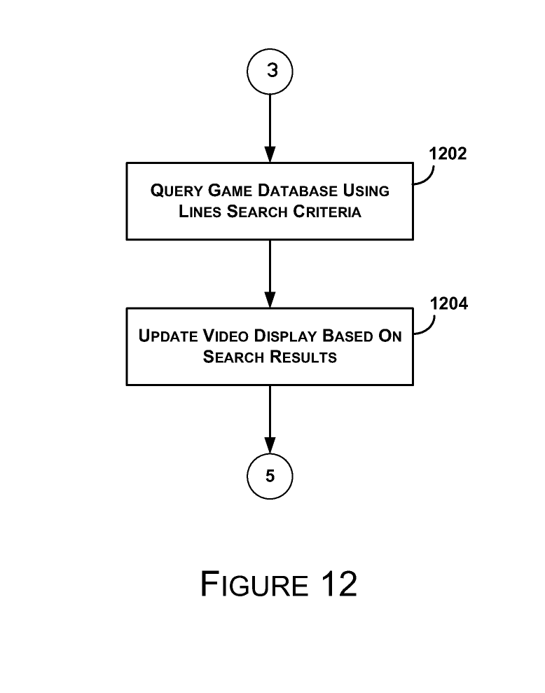

Returning to FIG. 6, if it is determined, at step 606, that top-level feature selection input has not been received, processing continues at step 608 to determine whether or not any top-level lines selection input was received. If so, processing continues at step 1202 of FIG. 12. At step 1202, the game database, e.g. data store 504, is queried to identify those video games having line(s)/way(s) characteristics. Processing continues at step 1204 to update the video display based on the results of the search, e.g. to display those video games having line(s)/way(s) characteristics and to exclude those games that lack a line(s)/way(s) characteristic. Processing continues at step 604 of FIG. 6.

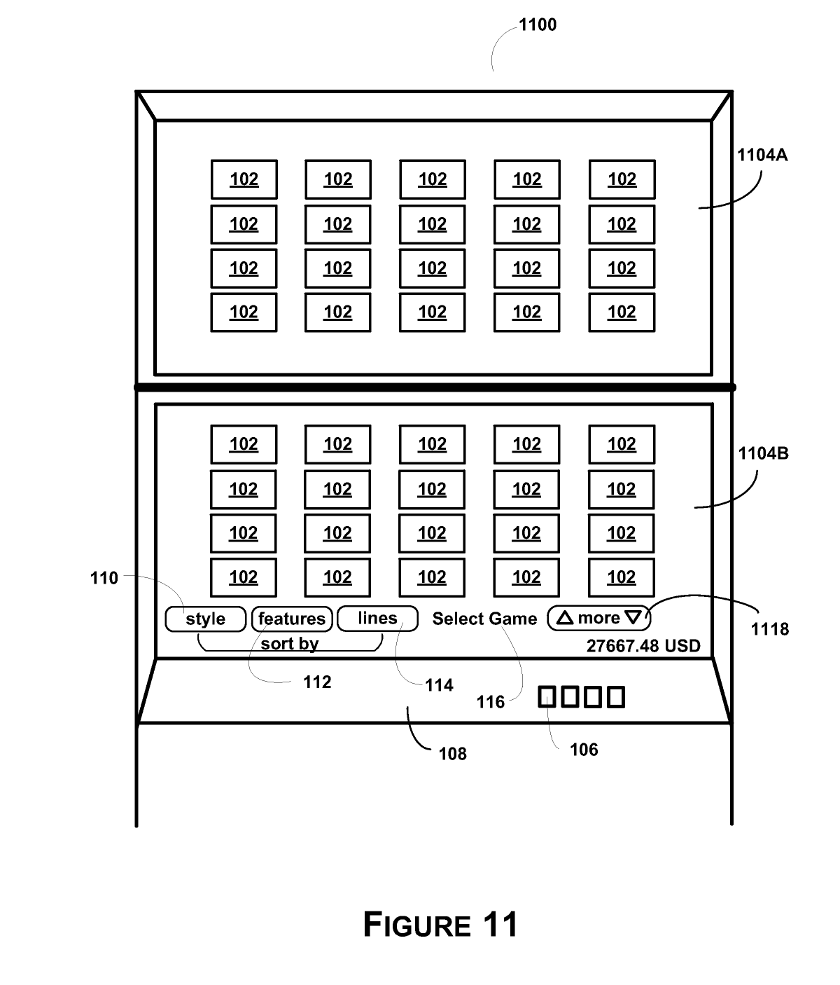

Returning to FIG. 6, if it is determined, at step 608, that top-level lines selection input has not been received, processing continues at step 610 to determine whether or not any top-level all games selection input was received. If so, processing continues at step 616 to select all of the video games for display via one or more video displays 104. FIG. 11 provides an example of the gaming machine 100 displaying video game indicia in response to an all games selection. In the example of FIG. 11, video displays 1104A and 1104B are displaying indicia 102 of the video games. In addition and in a case that additional video games are available whose indicia 102 is not being displayed, the player may using a scrolling capability via indicia 1118.

Returning to FIG. 6, if it is determined, at step 610, that top-level all games selection input was not received, processing continues at step 612 to determine whether or not the player made a video game selection. If so, processing continues at step 614 to start the video game. In accordance with at least one embodiment, the top-level menu may be displayed while the video game is being played. Alternatively, an option may be made available to the user, e.g. via a selectable indicia displayed by a video display 104, a selectable button 106, etc. to display the top-level menu, the style menu and/or the features menu.

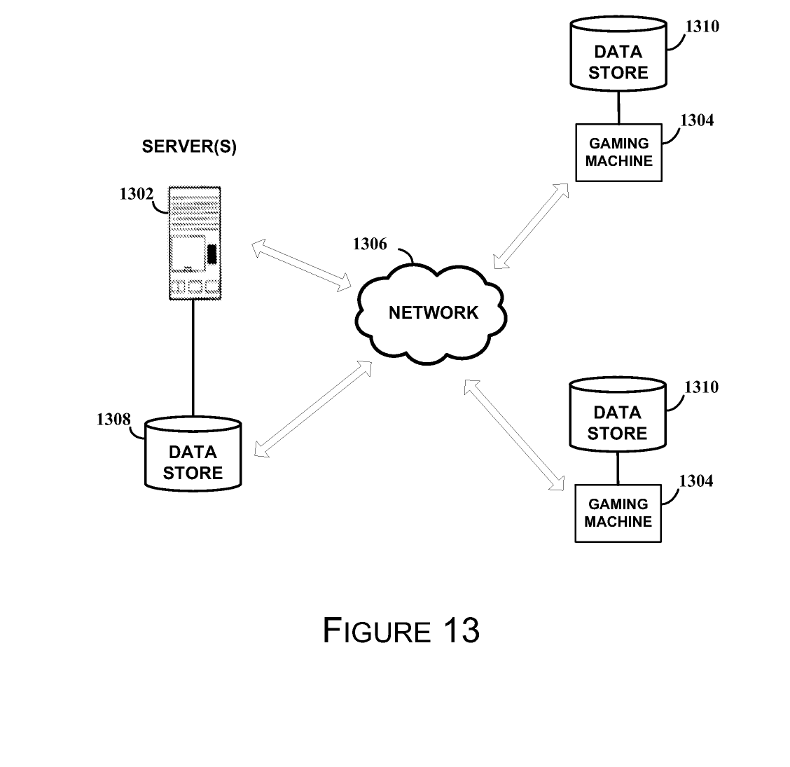

FIG. 13 diagrammatically illustrates system components including one or more gaming machines. In the example shown, the gaming machine 1304, which may correspond to the gaming machine 100, may be coupled to a data store 1304, which data store 1304 may be internal to the gaming machine 1304 or otherwise local to the gaming machine 1304. Alternatively, the data store may be a remote data store relative to the gaming machine 1304, such as data store 1308, which may be accessed via network 1306. Network 1306 may comprise a local area network, such as a casino's local area network, a wide area network, the Internet, etc. Data store 1308 may be local to a server 1302 and may be accessible by the gaming machine 1304. One or more of data stores 1304 and 1308 may correspond to data store 504. Some or all of engine 502 may be implemented using the server(s) 1302, the gaming machine(s) 1304 or some combination thereof.

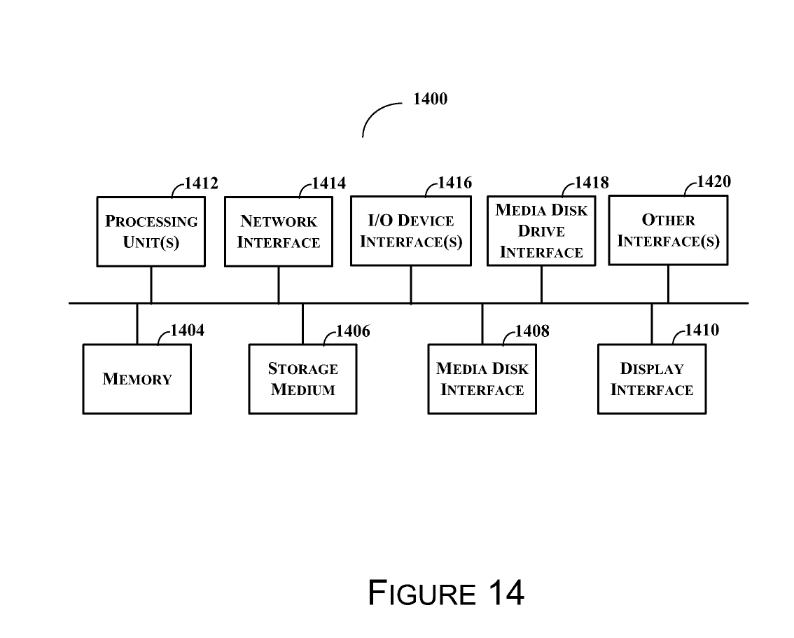

FIG. 14 is a detailed block diagram illustrating an internal architecture of a computing device, e.g. a computing device of the gaming machine 100/1304 or server 1302. As shown in FIG. 14, internal architecture 1400 includes one or more processing units, processors, or processing cores, (also referred to herein as CPUs) 1412, which interface with other components of the computing device, such as computer-readable storage medium, or media, 1406, network interface 1414, memory 1404, e.g., random access memory (RAM), run-time transient memory, read only memory (ROM), etc., media disk drive interface 1420 as an interface for a drive that can read and/or write to media including removable media such as floppy, CD-ROM, DVD, etc. media, display interface 1410 as interface for a monitor or other display device, e.g. video display(s) 104, keyboard interface 1416 as interface for a keyboard, pointing device, interface 1418 as an interface for a mouse or other pointing device, and miscellaneous other interfaces not shown individually, such as parallel and serial port interfaces, a universal serial bus (USB) interface, and the like.

Memory 1404 may provide information stored in memory 1404 to CPU 1412 during execution of software programs such as an operating system, application programs, device drivers, and software modules that comprise program code, and/or computer-executable process steps, incorporating functionality described herein, e.g., one or more of process flows described herein. CPU 1412 may load computer-executable process steps from storage, e.g., memory 1404, computer-readable storage medium/media 1406, removable media drive, and/or other storage device. CPU 1412 can then execute the stored process steps in order to execute the loaded computer-executable process steps. Stored data, e.g., data stored by a storage device, can be accessed by CPU 1412 during the execution of computer-executable process steps.

Persistent storage, e.g., medium/media 1406, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein. Persistent storage 1406 may comprise data stores 504, 1310 and/or 1308.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A casino gaming machine comprising:
at least one video display for displaying a video game search interface, the interface comprising at least one video game presentation area for displaying one or more video game indicia selectable by a player to play a corresponding video game and at least one search criteria indicia selectable by the player to search information about a plurality of video games available for play using the gaming machine, the information comprising game characteristics and each of the at least one search criteria indicia corresponding to at least one of the game characteristics;
at least one interface communicatively coupled to at least one data store storing the information about the plurality of video games;
at least one processor configured to cause a search of the at least one data store in response to input indicating a selected search criteria indicia, and to display at least one video game indicia selectable by the player and corresponding to a video game of the plurality of video games, each of the least one video game indicia corresponding to a video game having at least one characteristic satisfying the search criteria of the selected search criteria indicia.

2. The casino gaming machine of claim 1, wherein the video game search interface comprises a style characteristics menu comprising at least one selectable style characteristics search criteria indicia.

3. The casino gaming machine of claim 1, wherein the video game search interface comprises a features characteristics menu comprising at least one selectable feature characteristics search criteria indicia.

4. The casino gaming machine of claim 1, wherein the video game search interface comprises a line characteristics menu comprising at least one selectable line characteristics search criteria indicia.

5. The casino gaming machine of claim 1, wherein the video game search interface comprises a top-level menu comprising one or more of a style, features and lines selectable search criteria indicia.

6. The casino gaming machine of claim 1, wherein the video game search interface comprises a selectable “Top n” ranking indicia.

7. A method comprising:
displaying a video game search interface on at least one video display of a casino gaming machine, the interface comprising at least one video game presentation area for displaying one or more video game indicia selectable by a player to play a corresponding video game and at least one search criteria indicia selectable by the player to search information about a plurality of video games available for play using the gaming machine, the information comprising game characteristics and each of the at least one search criteria indicia corresponding to at least one of the game characteristics;
storing, by at least one data store, information about the plurality of video games; and
in response to receiving input indicating a selected search criteria indicia, at least one processing unit:
searching the at least one data store to identify at least one video game having at least one characteristic satisfying the search criteria of the selected search criteria indicia; and
displaying at least one video game indicia selectable by the player, each of the at least one video game indicia corresponding to a video game of the plurality of video games having at least one characteristic satisfying the search criteria of the selected search criteria indicia.

8. The method of claim 7, wherein the video game search interface comprises a style characteristics menu comprising at least one selectable style characteristics search criteria indicia.

9. The method of claim 7, wherein the video game search interface comprises a features characteristics menu comprising at least one selectable feature characteristics search criteria indicia.

10. The method of claim 7, wherein the video game search interface comprises a lines characteristics menu comprising at least one selectable line characteristics search criteria indica.

11. The method of claim 7, wherein the video game search interface comprises a top-level menu comprising one or more of a style, features and lines selectable search criteria indicia.

10. The method of claim 7, wherein the video game search interface comprises a selectable “Top n” ranking indicia.
